(19) United States
(12) Patent Application Publication
(10) Pub. No.: US 2017/0275954 A1
(43) Pub. Date: Sep. 28, 2017

(54) PRESSURE COMPENSATION MECHANISM FOR A SEAL ASSEMBLY OF A ROTARY DRILLING DEVICE

(71) Applicant: HALLIBURTON ENERGY SERVICES, INC., Houston, TX (US)

(72) Inventor: Everett P. HAGAR, Devon (CA)

(73) Assignee: HALLIBURTON ENERGY SERVICES, INC., Houston, TX (US)

(21) Appl. No.: 15/511,133

(22) PCT Filed: Oct. 3, 2014
(86) PCT No.: PCT/US2014/059088

§ 371 Date: Mar. 14, 2017

(51) Int. Cl. E21B 17/046; F16J 15/00; F16J 15/16; E21B 4/00

(52) U.S. Cl. CPC E21B 17/046; E21B 4/003; F16J 15/006; F16J 15/16; F16J 15/3416

(57) ABSTRACT

A downhole rotary seal assembly is provided that includes a primary rotary seal, a barrier seal, and a seal carrier. The seal carrier includes an inner surface, an outer surface, and a first groove dimensioned to receive the primary rotary seal at the inner surface. The seal carrier also includes a second groove dimensioned to receive the barrier seal at the inner surface. An aperture is defined on the inner surface between the first groove and the second groove. A relief port is positioned between the first groove and the second groove, the relief port being positioned to fluidly couple the aperture and the outer surface. A valve provided in the relief port. The valve includes a check valve having a predefined crack pressure.

### FIELD

The present disclosure relates generally to drilling systems, and particularly to a drilling system for oil and gas exploration and production operations. More specifically, the present disclosure provides a seal pressure compensation mechanism for a lower rotary seal assembly of a rotary drilling device.

### BACKGROUND

Directional drilling in oil and gas exploration and production has been used to reach subterranean destinations or formations with a drilling string. One type of directional drilling involves rotary steerable drilling systems that allow a drill string to rotate continuously while steering the drill string to a desired target location in a subterranean formation. Rotary steerable drilling systems are generally positioned at a lower end of the drill string and typically include a rotating drill shaft or mandrel, a housing that supports the rotating drill shaft, and additional components that seal a space between the housing and the rotating drill shaft from entry of drilling fluids and other debris. Under normal operating conditions, a hydrostatic pressure exerted on the drill string increases with drilling depth. What is needed is a seal pressure compensation mechanism for a lower rotary seal assembly located at a lower end of the drill string.

### BRIEF DESCRIPTION OF THE DRAWINGS

Implementations of the present technology will now be described, by way of example only, with reference to the attached figures, wherein:

FIG. 1 is a partial cross-sectional view illustrating an embodiment of a drilling rig for drilling a wellbore with the drilling system configured in accordance with the principles of the present disclosure;

FIG. 2 is a perspective view of one embodiment of a rotary steerable drilling device having a pressure compensation mechanism according to the present disclosure;

FIG. 3 is a schematic, transverse cross-sectional view of a seal pressure compensation mechanism illustrated in FIG. 2, which is situated at the lower end of a drillpipe, according to the present disclosure;

FIG. 4 is a close-up schematic, transverse cross-sectional view of the pressure compensation mechanism illustrated in FIG. 3 according to the present disclosure;

FIG. 5 is a cross-sectional view of the pressure compensation mechanism illustrated in FIG. 2 according to the present disclosure;

FIG. 6 is a schematic, transverse cross-sectional view of a seal pressure compensation mechanism according to a second embodiment of the present disclosure;

FIG. 7 is a cross-sectional view of a pressure compensation mechanism illustrated in FIG. 6 according to a second embodiment of the present disclosure;

FIG. 8 is a flowchart of an example method according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

In the following description, terms such as “upper,” “upward,” “lower,” “downward,” “above,” “below,” “downhole,” “uphole,” “longitudinal,” “lateral,” and the like, as used herein, shall mean in relation to the bottom or furthest extent of, the surrounding wellbore even though the wellbore or portions of it may be deviated or horizontal. Correspondingly, the transverse, axial, lateral, longitudinal, radial, and the like orientations shall mean positions relative to the orientation of the wellbore or tool. Additionally, the illustrated embodiments are depicted so that the orientation is such that the right-hand side is downhole compared to the left-hand side.

Several definitions that apply throughout this disclosure will now be presented. The term “coupled” is defined as connected, whether directly or indirectly through intervening components, and is not necessarily limited to physical connections. The connection can be such that the objects are permanently connected or releasably connected. The term “communicatively coupled” is defined as connected, either directly or indirectly through intervening components, and the connections are not necessarily limited to physical connections, but are connections that accommodate the transfer of data, fluids, or other matter between the so-described components. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other thing that “substantially” modifies, such that the component need not be exact. For example, substantially cylindrical means that the object resembles a cylinder, but can have one or more deviations from a true cylinder. The terms “comprising,” “including” and “having” are used interchangeably in this disclosure. The terms “comprising,” “including” and “having” mean to include, but not necessarily be limited to the things so described.

The term “radial” and/or “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

The term “drillpipe” means any conduit that extends downhole to support drilling operations. The drillpipe is coupled to a drill bit provided at the downhole end of the drillpipe. The drillpipe may include a drill string, coil tubing, or any other conduit that extends downhole to support drilling or workover operations. The drill string may include drillpipe of pre-determined lengths, such as 30 feet, 90 feet, or the like. The coil tubing may include continuous piping of several hundred feet or greater or less.

“Processor” as used herein is an electronic circuit that can make determinations based upon inputs and is interchangeable with the term “controller”. A processor can include a microprocessor, a microcontroller, and a central processing unit, among others. While a single processor can be used, the present disclosure can be implemented over a plurality of processors, including local controllers provided in a tool or sensors provided along the drillpipe.

According to one example, open-hole operations are employed during well construction. The open-hole operations typically include forming casing strings, such as a surface casing and intermediate casing. If a well is determined to be viable, then well completion may include forming a production casing for cased-hole operations.

Disclosed herein is a seal pressure compensation mechanism for a rotary seal assembly provided on a downhole portion of a drillpipe. The rotary seal assembly may include a seal carrier having grooves that seat a primary rotary seal and a barrier seal. The primary rotary seal may be positioned between a rotating drilling shaft or mandrel and a non-rotating housing of the drillpipe to form a seal between internal and external components of the drillpipe. The barrier seal may be positioned between the rotating drilling shaft and the non-rotating housing of the drillpipe and may be situated further downhole and closer to the drill bit as compared to the primary rotary seal. The primary rotary seal and the barrier seal are oriented relative to each other such that the barrier seal reduces exposure of the primary rotary seal to drilling fluid and other debris originating from outside the drillpipe. Thus, the barrier seal may be provided to increase a life span of the primary rotary seal. One of ordinary skill in the art will readily appreciate that the rotary seal assembly may include a seal carrier having grooves that seat a plurality of primary rotary seals and/or a plurality of barrier seals.

The barrier seal may be radially positioned between the rotating drilling shaft and the housing. According to one example, the barrier seal may be provided adjacent or proximate to the downhole end of the housing and may contact a wear sleeve provided on the rotating drilling shaft. In this way, the housing may define a compartment or container for the contents located therein. According to one example, the compartment may be an enclosed compartment when sealed.

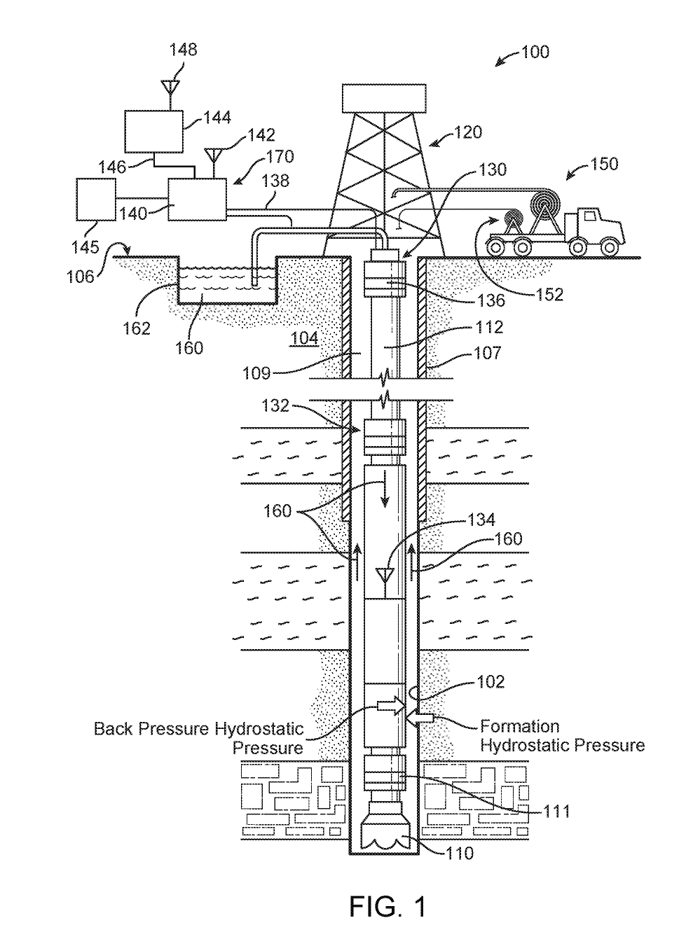

FIG. 1 schematically illustrates an open-hole drilling operation 100 used to form a subterranean well according to one example. The subterranean well is illustrated with a wellbore 102 drilled into the earth 104 from the ground's surface 106 using a drill bit 110 provided on a drillpipe 112. For illustrative purposes, the top portion of the wellbore 102 includes the surface casing 107, which is typically at least partially comprised of cement and which defines and stabilizes the wellbore 102 after being drilled. The wellbore 102 also may include intermediate casings (not shown), which may be stabilized with cement. The cement performs several functions, including preventing wellbore collapse, maintaining a physical separation between the Earth's layers, providing a barrier to prevent fluid migration, enhancing safety, and protecting the Earth's layers from any contaminants introduced during open-hole operations, or the like.

The drill bit 110 is located at the bottom, distal end of the drillpipe 112 that supports various components along its length. During the open-hole operations, the drill bit 110 and the drillpipe 112 are advanced into the earth 104 by a drilling rig 120. The drilling rig 120 may be supported directly on land as illustrated or on an intermediate platform if at sea.

The wellbore 102, which is illustrated extending downhole into the Earth's layers, and any components inside the wellbore 102 are subjected to hydrostatic pressure originating from subterranean destinations or formations. The hydrostatic pressure acting on the drillpipe 112 provided inside the wellbore 102 is identified as formation hydrostatic pressure. The hydrostatic pressure originating from within the drillpipe 112 is identified as backpressure hydrostatic pressure. As the drilling depth increases, a hydrostatic pressure differential may develop between the outside formation hydrostatic pressure and the backpressure hydrostatic pressure. For example, the hydrostatic pressure differential may increase as the drilling depth increases. If the hydrostatic pressure differential acting on the drillpipe 112 is not compensated, then hydrostatic pressure differential may crush the drillpipe 112 and/or force minerals, such as oil and gas, into the drillpipe 112. In either situation, the effect of the hydrostatic pressure differential may disrupt drilling operations.

The lower end portion of the drillpipe 112 may include a drill collar proximate the drilling bit 110. The drill bit 110 may take the form of a roller cone bit or fixed cutter bit or any other type of bit known in the art. Sensor sub-units 130, 132 are shown within the cased portion of the well and can be enabled to sense nearby characteristics and conditions of the drillpipe, formation fluid, casing, and surrounding formation. Data indicative of sensed conditions and characteristics is either recorded downhole, for instance at a processor (now shown) for later download or communicated to the surface either by wire using repeaters 134,136 up to surface wire 138, or wirelessly or otherwise. If wirelessly, the downhole transceiver (antenna) 134 may be utilized to send data to a local processor 140, via surface transceiver (antenna) 142. The data may be either processed at processor 140 or further transmitted along to a remote processor 144 via wire 146 or wirelessly via antennae 142 and 148. A surface installation 170 may be provided to send and receive data to and from the well via repeaters 134,136. The data may include well conditions such as formation hydrostatic pressure, backpressure hydrostatic pressure, well depth, temperatures, or the like. For purposes of completeness, FIG. 1 illustrates coiled tubing 150 and wireline 152 deployment, which are contemplated and within the context of this disclosure.

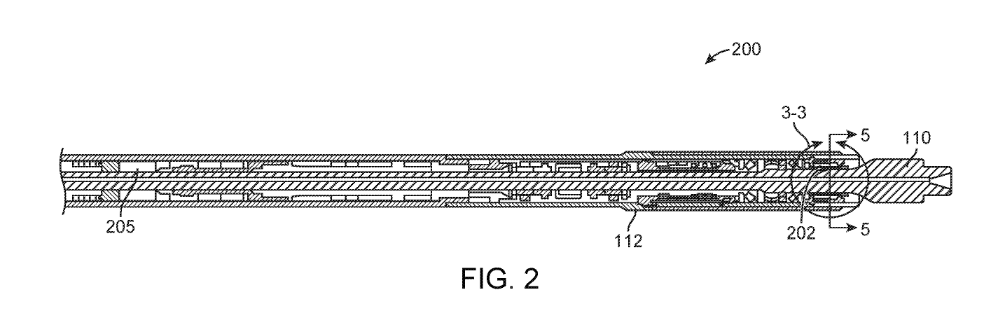

FIG. 2 illustrates a close-up of the lower, downhole portion 200 of the drillpipe 112 with the rotary seal assembly 202 provided proximate to the drill bit 110 according to one example. An oil reservoir 205 may be provided to supply oil to the seal pressure compensation mechanism.

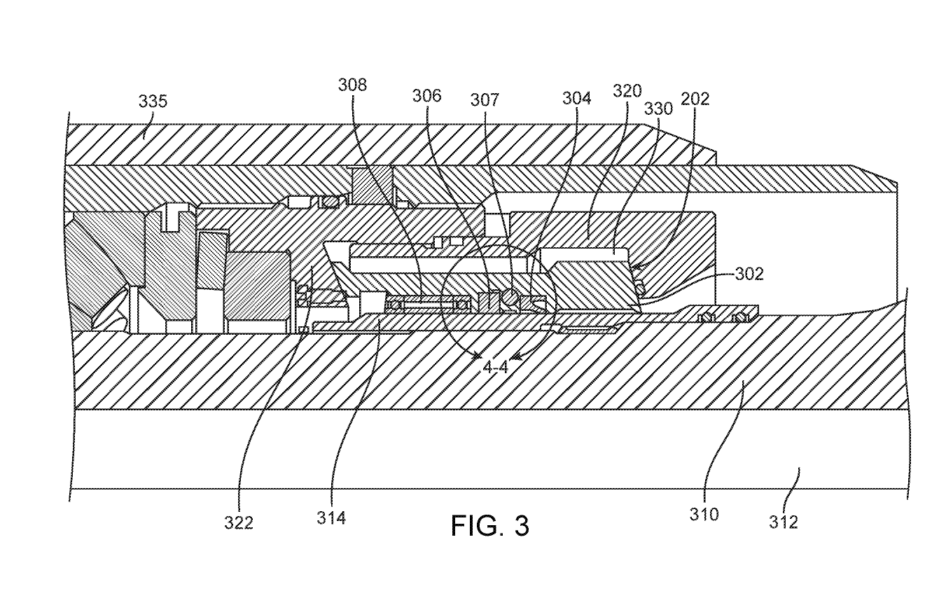

With reference to FIGS. 2 and 3, the rotary seal assembly 202 is illustrated to include a seal carrier 302 that seats a barrier seal 304 and a primary rotary seal 306. According to one example, the seal carrier 302 may be substantially cylinder-shaped and may include an inner circumference that defines an inner surface and an outer circumference that defines an outer surface. The inner surface may include grooves that receive the barrier seal 304 and the primary rotary seal 306. The inner surface and the outer surface may include surface contours that generally conform to surface shapes of adjacent objects. The barrier seal 304 and the primary rotary seal 306 may be provided proximate to the drive shaft 310 at the inner surface of the seal carrier 302. According to one example, the barrier seal 304 may include a lip cantilever seal or the like, while the primary rotary seal 306 may include a KALSI® seal. One of ordinary skill in the art will readily appreciate that other types of seals may be employed. Additionally, one of ordinary skill in the art will readily appreciate that any number of seals may be provided at the seal carrier 302.

The rotary seal assembly 202 provides a transition between the stationary housing 335 and the rotating driveshaft 310. The seal carrier 302 also may include a recess portion that receives a bearing 308 that facilitates rotation of a driveshaft 310 relative to the rotary seal assembly 202. The driveshaft 310 may include a conduit 312 therethrough for passing drilling fluid through an interior of the driveshaft 310 during drilling operations. The conduit 312 may be tubular or hollow to permit drilling fluid (mud) to flow therethrough in a relatively unrestricted and unimpeded manner. The driveshaft 310 may be formed from any material suitable for and compatible with rotary drilling. According to one example, the driveshaft 310 may be formed from high strength stainless steel.

With reference to FIG. 1, a drilling fluid 160 may be circulated through the drilling components to perform functions such as preventing blow-out and preventing collapse of the wellbore 102. According to one example, the drilling fluid 160 may be circulated during drilling operations through the driveshaft 310, the drill bit 110, and the annulus 109. According to one example, the drill bit 110 may include nozzles that direct a flow of the drilling fluid 160. After passing through the drilling components, the drilling fluid 160 may be circulated to the surface 106, where it passes through a filter (not shown) to remove any drilling debris, such as cuttings or the like. According to one example, the filter may include a shale shaker or the like. The filtered drilling fluid 160 may be collected in a tank 162 for re-circulation through the drilling components. The drilling fluid 160 may be formulated to perform other functions, including lubricating the drill bit 110, cooling the drill bit 110, flushing drilling debris such as rock away from the drill bit 110 and upward to the Earth's surface 106 through the annulus 109 formed between the wellbore 102 and the drillpipe 112, and reducing friction between the drillpipe 112 and the wellbore 102, or the like.

Returning to FIG. 3, a wear sleeve 314 may be provided around the driveshaft 310 at the rotary seal assembly 202 to protect the driveshaft 310 from wear due to friction, heat, and other forces originating from contact with the bearing 308 and the rotary seal assembly 202. The rotary seal assembly 202 may be held between connectors 320,322 and the wear sleeve 314. According to one example, an interior surface of the connectors 320, 322 may generally corresponds in shape to an exterior surface of the rotary seal assembly 202. Furthermore, a gap 330 may be provided between the interior surface of the connectors 320,322 and the exterior surface of the rotary seal assembly 202 to allow for flexing of the driveshaft 310 in a radial direction within the housing 335. The rotary seal assembly 202 may include a relief port 307 situated between the primary rotary seal 306 and the barrier seal 304 to equalize pressure between these seals.

As a point of reference, the hydrostatic pressure during downhole operations may exceed 20,000 pounds per square inch (“psi”). Without a seal pressure compensation mechanism for the seals, the barrier seal 304 and the primary rotary seal 306 may be subjected to large net pressure differentials during downhole operations. Under such conditions, the barrier seal 304 and the primary rotary seal 306 may deform and fail. Due to size limitations within the drillpipe 112 in the area proximate to the barrier seal of 304 and the primary rotary seal 306, it may not be feasible to employ balance piston structures to hydrostatically equalize these seals.

By way of comparison, a separate tool pressure compensation system is typically employed within drilling tools to prevent large net pressure differentials from developing on the drillpipe 112 during downhole operations. The tool pressure compensation systems are designed to include various seals that counteract external hydrostatic pressure acting on the drillpipe 112. If not properly equalized, the external hydrostatic pressure may deform the drillpipe 112, which may cause drilling tools located within the drillpipe 112 to fail.

According to one example, drilling tools provided within the drillpipe 112 may include a tool pressure compensation system, such as a pressure-responsive piston and a pressuring pump. The tool pressure compensation system may include a balance piston that hydrostatically equalizes the pressure of components inside the drillpipe 112 against hydrostatic pressure exerted on an outside surface of the drillpipe 112. One of ordinary skill in the art will readily appreciate that mechanisms other than pressure-responsive pistons may be employed to compensate for any pressure differentials.

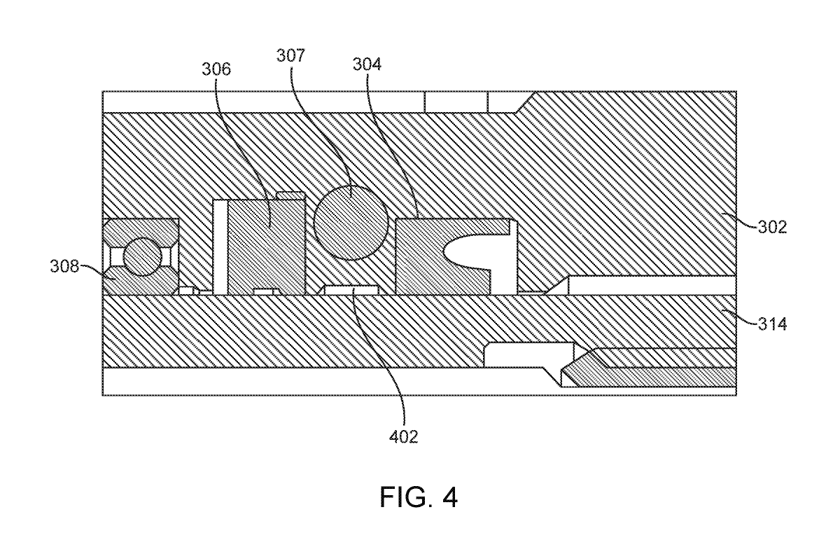

With reference to FIGS. 3 and 4, a void may be provided at the inner surface of the seal carrier 302 between the grooves that receive the primary rotary seal 306 and the barrier seal 304. According to one example, the void may define an aperture 402 between the primary rotary seal 306 and the barrier seal 304. When the rotary seal assembly 202 is assembled to the driveshaft 310 in an ambient pressure environment such as at sea level, the primary rotary seal 306 and the barrier seal 304 may trap the ambient pressure within the aperture 402. With respect to the barrier seal 304, a large net pressure differential may develop when the ambient pressure is trapped within the aperture 402 located at an interior side of the barrier seal 304. Under these conditions, the barrier seal 304 may be exposed to significant hydrostatic pressure that originates from an exterior side of the barrier seal 304. Again, as a point of reference, the hydrostatic pressure during downhole operations may exceed 20,000 pounds per square inch (“psi”). Without a seal pressure compensation mechanism, the barrier seal 304 may deform and fail. For example, a large net pressure differential may cause the barrier seal 304 to fold over and fail.

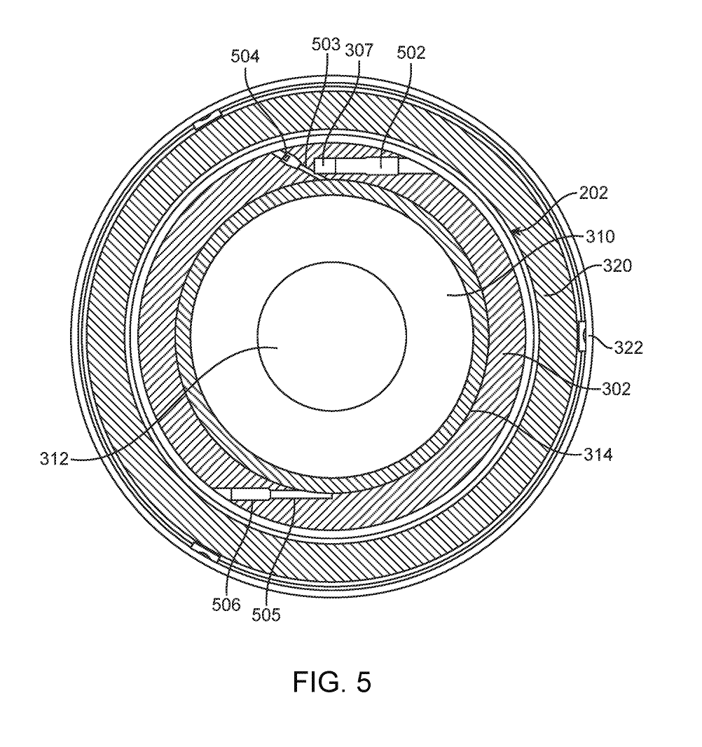

With reference to FIGS. 2 and 5, a cross-sectional view illustrates the rotary seal assembly 202 situated between connectors 320,322 and the wear sleeve 314. As illustrated, the relief port 307 is bored into the seal carrier 302 and a valve 502 is inserted into the relief port 307. According to one example, the valve 502 allows oil that originates from within the tool to flow through the relief port 307 into the aperture 402. According to one example, the oil may originate from within the gap 330 provided between the interior surface of the connectors 320,322 and the exterior surface of the rotary seal assembly 202. Accordingly, the valve 502 may fluidly couple the gap 330 and a primary fluid reservoir provided within the drillpipe 112. According to one example, the valve 502 may include a check valve or the like. The check valve may be a one way valve that releases pressure in a single direction. One of ordinary skill in the art will readily appreciate that other valves may be employed. Additionally, the seal carrier 302 may include cross-drilled ports 503,505 to account for any size differential associated with introducing the valve 502 into the seal carrier 302. If cross-drilled ports 503,505 are provided, then pressure plugs 504,506 may be employed to plug the cross-drilled ports 503,505. One of ordinary skill in the art will readily appreciate that other techniques may be used to appropriately size the seal carrier 302. Alternatively, one of ordinary skill in the art will readily appreciate that any sizing adjustments may be avoided altogether if the seal carrier 302 is appropriately sized during manufacture.

A check valve may be designed to open to enable fluid flow therethrough when a differential pressure across the check valve exceeds a crack pressure. For example, the fluid flow may be enabled in a single direction through the check valve. According to one example, the check valve may include a screen on the inlet side to prevent large particles from entering into and clogging the check valve. Furthermore, the check valve may be designed to close to block fluid flow therethrough when a differential pressure across the check valve is below the crack pressure. According to one example, when the valve 502 situated between the primary rotary seal 306 and the barrier seal 304 opens, it may draw fluid such as oil into the aperture 402 formed between the primary rotary 306 seal and the barrier seal 304. Any pressure differential between the primary rotary seal 306 and the barrier seal 304 may be equalized when the valve 502 opens and fluid may fill the aperture 402. According to one example, the valve 502 may be designed with a predetermined crack pressure. For example, the crack pressure may be in a range of 50 psi to 1,000 psi. Alternatively, the crack pressure may be in a range of 100 psi to 1,000 psi. One of ordinary skill in the art will readily appreciate that the valve 502 may be designed to support various crack pressures.

According to one example, a downhole tool may include a pressure compensation mechanism to counteract the hydrostatic pressure acting on the downhole tool. For example, if the hydrostatic pressure is 20,000 psi during downhole operations, then the pressure compensation mechanism of the downhole tool may generate a 20,000 psi back pressure to counteract the hydrostatic pressure acting thereon. Alternatively, the pressure compensation mechanism of the downhole tool may generate a 20,000 psi back pressure plus some additional back pressure to counteract the hydrostatic pressure acting thereon. For example, the additional back pressure may be in a range of 1 psi to 200 psi. Accordingly, the pressure compensation mechanism of the downhole tool may generate back pressure in a range of 20,001 psi to 20,200 psi to counteract hydrostatic pressure of 20,000 psi. One of ordinary skill in the art will readily appreciate that other values may be employed for the additional back pressure.

Returning to the example above, if the hydrostatic pressure is 20,000 psi during downhole operations, then the pressure compensation mechanism of the downhole tool may generate a 20,000 psi back pressure to counteract the hydrostatic pressure acting thereon. In this example, no additional back pressure is being applied. If a valve 502 having a crack pressure of 1,000 psi is selected, then the pressure within the aperture 402 may be equalized to approximately 19,050 psi, which is the value of the crack pressure below the internal pressure of the drillpipe 112. In this example, 19,050 psi is approximately 1,000 psi below the 20,000 psi internal pressure of the drillpipe 112. Furthermore, with the aperture 402 equalized to 19,050 psi, the pressure exerted across the barrier seal 304 is approximately 950 psi (or 20,000 psi−19,050 psi). Additionally, if the aperture 402 is equalized to 19,050 psi, the pressure exerted across the primary rotary seal 306 is approximately 1,000 psi (or 20,000 psi−19,050 psi).

By comparison, without the seal pressure compensation mechanism, the pressure within the aperture 402 may remain at atmospheric pressure of approximately 15 psi during downhole operations. Under similar conditions as described above, with external hydrostatic pressure of 20,000 psi and internal backpressure of 20,000 psi, the pressure exerted across the barrier seal 304 would be approximately 19,985 psi (or 20,000 psi−15 psi). Furthermore, the pressure exerted across the primary rotary seal 306 would be approximately 20,985 psi (or 20,000 psi−15 psi). Under these pressure conditions, the barrier seal 304 may collapse, which may allow drilling fluid 160 to penetrate into the aperture 402. Once the drilling fluid reaches the aperture 402, then the drilling fluid 160 may contact the primary rotary seal 306. Direct contact between the drilling fluid 160 and the primary rotary seal 306 may cause damage and eventual failure of the primary rotary seal 306.

The seal pressure compensation mechanism described herein provides several advantages over existing piston compensation mechanisms employed for seal pressure compensation. For example, as compared to existing piston compensation mechanisms having a pressure-responsive piston, the seal pressure compensation mechanisms described herein offer reduced size due to the relief port 307 and valve 502 being smaller in size compared to the pressure-responsive piston mechanism. Additionally, the seal pressure compensation mechanism described herein draws oil from the tool pressure compensation and therefore does not require a separate reservoir. By contrast, existing piston compensation mechanisms employed for seal pressure compensation require a separate reservoir and a separate oil fill.

According to one example, the rotating driveshaft 310 generates heat that dissipates into adjacent components during drilling operations. The heat may cause oil within the aperture 402 to thermally expand and exert counter-pressure or back pressure against any oil flowing through the relief port 307 illustrated in FIG. 5. Accordingly, any oil passing through the relief port 307 may be subjected to counter-pressure due to the thermally expanded oil. Accordingly, heat generated by the driveshaft 310 may disrupt the flow of oil into the aperture 402.

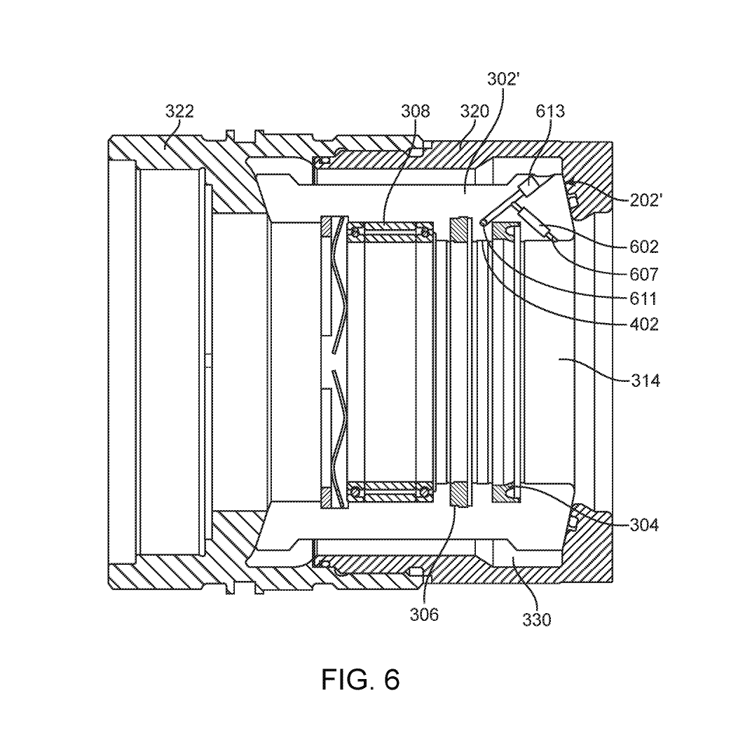

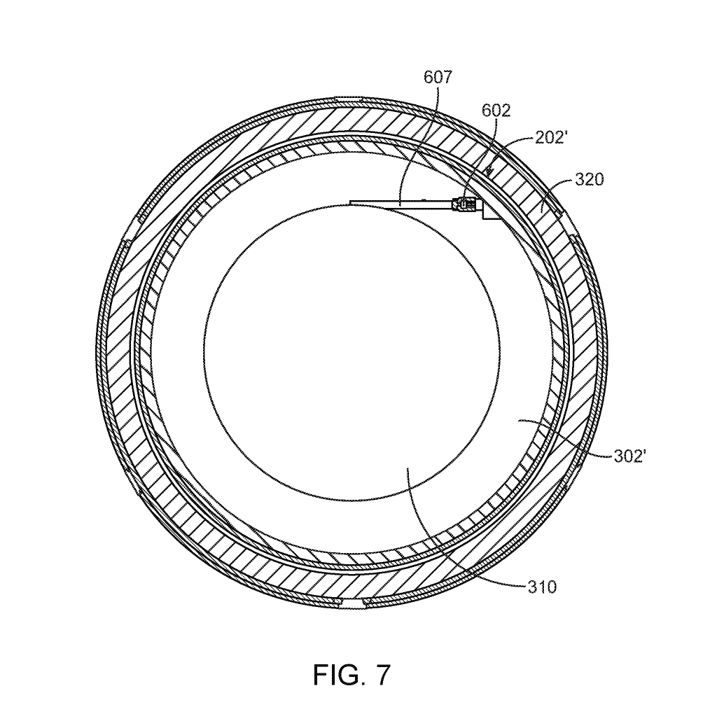

With reference to FIGS. 6 and 7, a cross-sectional view illustrates a rotary seal assembly 202′ situated between connectors 320,322 and the wear sleeve 314. As illustrated, the relief port 607 is bored into the seal carrier 302′ and a valve 602 is inserted into the relief port 607. The valve 602 allows oil originating from within the tool to flow through the relief port 607. According to one example, the valve 602 may include a check valve or the like. The check valve may be a one way valve that releases pressure in a single direction. One of ordinary skill in the art will readily appreciate that other valves may be employed.

According to one example, the relief port 607 may fluidly couple the aperture 402 to an area external to the drilling tool. For example, the relief port 607 may fluidly couple the aperture 402 to an area exposed to drilling fluid or mud. By providing a fluid path external to the drilling tool, the relief port 607 and valve 602 may prevent pressure lock from developing due to thermal expansion of oil within the aperture 402 inside the drilling tool.

According to one example, the rotary seal assembly 202′ may include both the relief port 607 and valve 602, along with the relief port 307 and valve 502 (not illustrated). In this configuration, the relief port 307 and valve 502 perform seal pressure compensation as discussed above. As discussed above, the relief port 607 and valve 602 coupling the aperture 401 to the drilling fluid prevent pressure locking due to thermal expansion. Additionally, the seal carrier 302′ may include a cross-drilled port 611 to account for any size differential associated with introducing the valve 602 into the seal carrier 302′. If cross-drilled port 611 is provided, then pressure plugs 613 may be employed to plug the cross-drilled ports 611. One of ordinary skill in the art will readily appreciate that other techniques may be used to appropriately size the seal carrier 302′. Alternatively, one of ordinary skill in the art will readily appreciate that any sizing adjustments may be avoided altogether if the seal carrier 302′ is appropriately sized during manufacture.

Returning to FIG. 1, an exemplary rotary steerable drilling device 111, which also may be referred to as a drilling direction control device or system, is schematically illustrated. The rotary drilling device 111 is positioned on the drillpipe 112 with drill bit 110. However, one of skill in the art will recognize that the positioning of the rotary steerable drilling device 111 on the drillpipe 112 and relative to other components on the drillpipe 112 may be modified while remaining within the scope of the present disclosure. The rotary steerable drilling device 111 may include a rotatable drilling shaft that is coupled or attached to a rotary drill bit 110 and to rotary drillpipe 112 during the drilling operation.

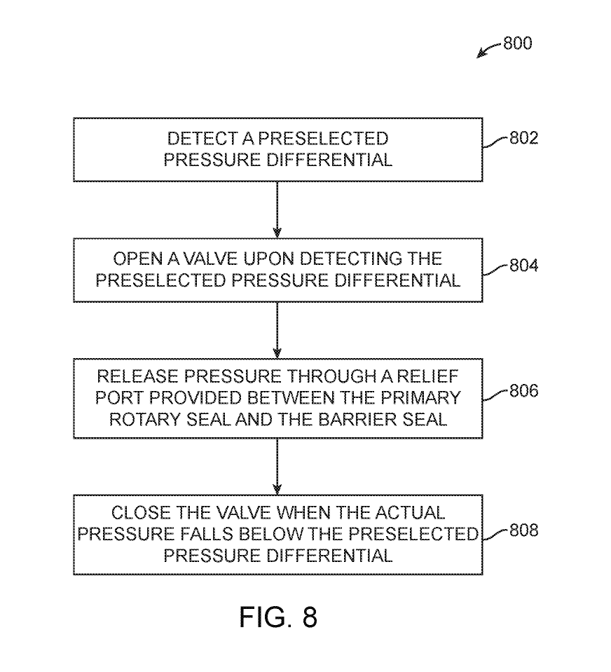

FIG. 8 is a flowchart of an example method 800 according to the present disclosure. The method 800 may be implemented using one or more of the above described components. For example, the method 800 may be implemented using a valve. The valve may be configured to control fluid flow through a relief port.

The method 800 may include detecting a preselected pressure differential (block 802). For example, the valve may be configured to detect a pressure differential of 1,000 psi. The valve may be configured as described above. The method 800 may further include opening a valve upon detecting the preselected pressure differential (block 804). For example, a check valve may be opened when the preselected pressure differential is detected. The method 800 also may include releasing pressure through a relief port provided between the primary rotary seal and the barrier seal. The valve may release pressure in a single direction through the relief port (block 806). Additionally, the method may include closing the valve when an actual pressure falls below the preselected pressure differential (block 808). In this way, the oil passing through the valve may be shut off to prevent depletion of the oil supply.

Numerous examples are provided herein to enhance understanding of the present disclosure. A specific set of examples are provided as follows. In a first example, a downhole rotary seal assembly is disclosed that includes a seal carrier having an inner surface; an outer surface; a first groove dimensioned to receive a first seal at the inner surface; a second groove dimensioned to receive a second seal at the inner surface; an aperture defined on the inner surface between the first groove and the second groove; a relief port positioned between the first groove and the second groove, the relief port being positioned to fluidly couple the aperture and the outer surface; and a valve provided in the relief port.

In a second example, there is disclosed herein the downhole rotary seal assembly according to the first example, wherein the first groove is positioned uphole of the second groove and wherein the first seal is a primary rotary seal and the second seal is a barrier seal.

In a third example, there is disclosed herein the downhole rotary seal assembly according to the first or second examples, wherein the valve is a check valve having a predefined crack pressure.

In a fourth example, there is disclosed herein the rotary seal assembly according to any of the preceding examples first to the third, wherein the seal carrier further comprises a second relief port positioned between the first groove and the second groove, the second relief port being positioned to fluidly couple the aperture and an area outside the downhole rotary seal assembly.

In a fifth example, there is disclosed herein the rotary seal assembly according to any of the preceding examples first to the fourth, wherein the check valve is a one way valve.

In a sixth example, there is disclosed herein the rotary seal assembly according to any of the preceding examples first to the fifth, wherein the seal carrier is dimensioned to fit over a driveshaft.

In a seventh example, there is disclosed herein the rotary seal assembly according to any of the preceding examples first to the sixth, wherein the seal carrier further includes at least one cross-drilled port and at least one pressure plug provided in the at least one cross-drilled port.

In an eighth example, a downhole rotary seal assembly is disclosed that includes a primary rotary seal; a barrier seal; and a seal carrier having an inner surface; an outer surface; a first groove dimensioned to receive the primary rotary seal at the inner surface; a second groove dimensioned to receive the barrier seal at the inner surface; an aperture defined on the inner surface between the first groove and the second groove; a relief port positioned between the first groove and the second groove, the relief port being positioned to fluidly couple the aperture and the outer surface; and a valve provided in the relief port.

In a ninth example, there is disclosed herein a downhole rotary seal assembly according to the preceding eighth example, wherein the first groove is positioned uphole of the second groove.

In a tenth example, there is disclosed herein a downhole rotary seal assembly according to any of the preceding examples eighth to ninth, wherein the valve is a check valve having a predefined crack pressure.

In an eleventh example, there is disclosed herein a downhole rotary seal assembly according to any of the preceding examples eighth to tenth, wherein the seal carrier further comprises a second relief port positioned between the first groove and the second groove, the second relief port being positioned to fluidly couple the aperture and an area outside the downhole rotary seal assembly.

In a twelfth example, there is disclosed herein a downhole rotary seal assembly according to any of the preceding examples eighth to eleventh, wherein the check valve is a one way valve.

In a thirteenth example, there is disclosed herein a method according to any of the preceding examples eighth to twelfth, wherein the seal carrier is dimensioned to fit over a portion of a driveshaft proximate to a drill bit.

In a fourteenth example a method is disclosed for equalizing pressure at an aperture positioned between a primary rotary seal and a barrier seal during downhole operations, the method includes detecting a preselected pressure differential between the aperture and an internal pressure; opening a valve upon detecting the preselected pressure differential; releasing pressure through the valve provided in a relief port located between the primary rotary seal and the barrier seal; and closing the valve when an actual pressure falls below the preselected pressure differential.

In a fifteenth example, there is disclosed herein the method according to the fourteenth example, wherein the pressure is released through the relief port in a single direction.

In a sixteenth example, there is disclosed herein the method according to the examples fourteenth and fifteenth, further comprising detecting a second preselected pressure differential between the aperture and an external pressure; opening a second valve upon detecting the second preselected pressure differential; releasing pressure through the second valve provided in a second relief port between the primary rotary seal and the barrier seal; and closing the second valve when a second actual pressure falls below the second preselected pressure differential.

In a seventeenth example, there is disclosed herein the method according to the examples fourteenth and sixteenth, wherein the valve is a check valve that automatically opens and closes based on the preselected pressure differential.

In an eighteenth example, there is disclosed herein the method according to the examples fourteenth and seventeenth, wherein the releasing pressure through the relief port includes passing oil through the relief port.

In a nineteenth example, there is disclosed herein the method according to the examples fourteenth and eighteenth, wherein the oil fills an aperture defined between the primary rotary seal and the barrier seal.

In a twentieth example, there is disclosed herein the method according to the examples fourteenth and nineteenth, wherein the preselected pressure differential is greater than 25 pounds per square inch.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

What is claimed is:

1. A downhole rotary drilling device comprising:
a rotatable drilling shaft;
a rotary drill bit coupled to the rotatable drilling shaft; and
a rotary seal assembly, proximate to the rotary drill bit, comprising a seal carrier comprising:
an inner surface;
an outer surface;
a first groove dimensioned to receive a first seal at the inner surface;
a second groove dimensioned to receive a second seal at the inner surface;
an aperture defined on the inner surface between the first groove and the second groove;
a relief port positioned between the first groove and the second groove, the relief port being positioned to fluidly couple the aperture and the outer surface; and
a valve provided in the relief port.

2. The downhole rotary drilling device of claim 1, wherein the first groove is positioned uphole of the second groove and wherein the first seal is a primary rotary seal and the second seal is a barrier seal.

3. The downhole rotary drilling device of claim 1, wherein the valve is a check valve having a predefined crack pressure.

4. The downhole rotary drilling device of claim 1, wherein the seal carrier further comprises a second relief port positioned between the first groove and the second groove, the second relief port being positioned to fluidly couple the aperture and an area outside the downhole rotary seal assembly.

5. The downhole rotary drilling device of claim 3, wherein the check valve is a one way valve.

6. The downhole rotary drilling device of claim 1, wherein the seal carrier is dimensioned to fit over a driveshaft.

7. The downhole rotary drilling device of claim 1, wherein the seal carrier further includes at least one cross-drilled port and at least one pressure plug provided in the at least one cross-drilled port.

8. A downhole rotary drilling tool, having oil therein, comprising:
a rotatable drilling shaft;
a rotary drill bit coupled to the rotatable drilling shaft; and
a rotary seal assembly, proximate to the rotary drill bit, comprising:
a primary rotary seal;
a barrier seal; and
a seal carrier comprising:
an inner surface;
an outer surface;
a first groove dimensioned to receive the primary rotary seal at the inner surface;
a second groove dimensioned to receive the barrier seal at the inner surface;
an aperture defined on the inner surface between the first groove and the second groove;
a relief port positioned between the first groove and the second groove, the relief port being positioned to fluidly couple the aperture and the outer surface; and
a valve provided in the relief port, configured to allow oil from within the tool to flow through the relief port into the aperture to counteract external hydrostatic pressure.

9. The downhole rotary drilling tool of claim 8, wherein the first groove is positioned uphole of the second groove.

10. The downhole rotary drilling tool of claim 8, wherein the valve is a check valve having a predefined crack pressure.

11. The downhole rotary drilling tool of claim 8, wherein the seal carrier further comprises a second relief port positioned between the first groove and the second groove, the second relief port being positioned to fluidly couple the aperture and an area outside the downhole rotary seal assembly.

12. The downhole rotary drilling tool of claim 10, wherein the check valve is a one way valve.

13. The downhole rotary drilling tool of claim 8, wherein the seal carrier is dimensioned to fit over a portion of a driveshaft proximate to a drill bit.

14. A method for equalizing pressure at an aperture positioned between a primary rotary seal and a barrier seal during downhole operations, the method comprising:
detecting a preselected pressure differential between the aperture pressure and an internal pressure;
opening a valve upon detecting the preselected pressure differential;
releasing pressure through the valve provided in a relief port located between the primary rotary seal and the barrier seal; and
closing the valve when an actual pressure differential between the aperture pressure and the internal pressure falls below the preselected pressure differential.

15. The method for equalizing pressure according to claim 14, wherein the pressure is released through the relief port in a single direction.

16. The method for equalizing pressure according to claim 14, further comprising:
detecting a second preselected pressure differential between the aperture pressure and an external pressure;
opening a second valve upon detecting the second preselected pressure differential;
releasing pressure through the second valve provided in a second relief port between the primary rotary seal and the barrier seal; and
closing the second valve when a second actual pressure differential between the aperture pressure and the external pressure falls below the second preselected pressure differential.

17. The method for equalizing pressure according to claim 14, wherein the valve is a check valve that automatically opens and closes based on the preselected pressure differential.

18. The method for equalizing pressure according to claim 14, wherein releasing pressure through the relief port includes passing oil through the relief port.

19. The method for equalizing pressure according to claim 18, wherein the oil fills an aperture defined between the primary rotary seal and the barrier seal.

20. The method for equalizing pressure according to claim 14, wherein the preselected pressure differential is greater than 25 pounds per square inch.
